(19) United States
(12) Patent Application Publication
(10) Pub. No.: US 2015/0111189 A1
(43) Pub. Date: Apr. 23, 2015

(54) SYSTEM AND METHOD FOR BROWSING MULTIMEDIA FILE

(71) Applicants: INVENTEC (PUDONG) TECHNOLOGY CORPORATION, Shanghai (CN); INVENTEC CORPORATION, Taipei (TW)

(72) Inventor: Chaucer CHIU, Taipei (TW)

(73) Assignees: INVENTEC (PUDONG) TECHNOLOGY CORPORATION, Shanghai (CN); INVENTEC CORPORATION, Taipei (TW)

(21) Appl. No.: 14/283,350

(22) Filed: May 21, 2014

(30) Foreign Application Priority Data
Oct. 18, 2013 (CN) 201310492811.3

(51) Int. Cl. G06F 17/30; G09B 5/06

(52) U.S. Cl. CPC G06F 17/30076; G09B 5/065; G06F 17/30106
USPC 434/308

(57) ABSTRACT

A system and method for browsing a multimedia file are disclosed. In playing a multimedia teaching file, a content located within a text recognition area is converted into at least one image-text and a voice signal in the multimedia teaching file is converted into at least one voice-text. Then, an index comprising the image-texts and the respective image-time thereof and the voice-texts and the respective voice-time thereof is generated. Subsequently, after the image-time and the voice-time of the image-text and the voice-text corresponding to the keyword are read out from the index, respectively, the multimedia teaching file is played according to the read image-time and voice-time. Thus, the content of multimedia teaching file may be searched and played rapidly.

### BACKGROUND OF THE INVENTION

1. Field of Invention

The present invention relates to a multimedia file playing system and method, and particularly to a system and method for browsing a multimedia file based on an index establishing.

2. Related Art

With improvement of technology and development of the Internet, various activities have had a breakthrough beyond space. For example, although the traditional teaching patterns are usually realized at designated spots at given time. The Internet teaching may make other spots for classes, when some students are not at the designated spots at the designated time. As another choice, such students may attend the class by learning the class by using a teaching file as previously recorded in a multimedia form afterwards.

Furthermore, in the case that the students have not sufficiently comprehend the on-spot teaching content or the multimedia teaching content for some part, they may select to accept the teaching content by browsing the multimedia content again.

However, since it is not possible to search the content recorded in the multimedia file, and the students do not keep or record a beginning time of the fragmentation of the multimedia teaching file they desires to browse again, the students have to drag the displaying indicator on the timeline or fast forward multimedia teaching file, so as to locate the desired fragmentation of the multimedia file. Apparently, an inconvenience issue is arisen for the students.

In view of the above, the conventionally employed multimedia teaching file always involves the situation where a played multimedia file may not be freely searched and inconvenience is brought about to the learners. Accordingly, there is a need to set forth an improved technical means to solve this problem.

### SUMMARY

It is, therefore, an object of the present invention to provide a system for browsing a multimedia file, which comprises a recognition area setting module, setting a text recognition area in a multimedia teaching file, the text recognition area displaying an image of the multimedia teaching file; an image text converting module for converting the image into at least one image-text, and saving each of the image-texts and each image-time of the image-text; a speech text converting module for converting a voice signal of the multimedia teaching file into at least one voice-text, and saving each of the voice-texts and each voice-time of the voice-text; an index generating module for generating an index, which comprising each of the image-texts, the image-time of each image-text, each of the voice-text and the voice-time of each voice-text; an inputting module for inputting a keyword; a data processing module for searching the keyword in the index, confirming the image-text and the voice-text which are corresponding to the keyword in the index, and reading the image-time of the confirmed image-text and the voice-time of the confirmed voice-text in the index; and a file playing module for playing the multimedia teaching file according to the read image-time and the read voice-time.

The present invention to provide a method for browsing a multimedia file, which comprises steps of setting a text recognition area in a multimedia teaching file, the text recognition area displaying at least one image of the multimedia teaching file, each of the images corresponds to a image-time; converting the image into at least one image-text, and saving each of the image-texts and each of image-time of the image; converting a voice signal of the multimedia teaching file into at least one voice-text, and saving each of the voice-texts and each voice-time of the voice-text; generating an index which comprises each of the image-texts, the image-time of each image-text, each of the voice-texts and the voice-time of each voice-text; inputting a keyword; searching the keyword in the index, confirming the image-text and the voice-text which are corresponding to the keyword in the index, and reading the image-time of the confirmed image-text and the voice-time of the confirmed voice-text; and playing the multimedia teaching file according to the read image-time and the read voice-time.

The system and method of the present invention are summarized above, and the main differences of the present invention as compared to the prior art dwell in that a content located within a text recognition area, in playing a multimedia teaching file, is converted into at least one image-text and a voice signal in the multimedia teaching file is converted into a voice-text, an index comprising each of the image-texts and the respective image-time thereof and each of the voice-texts and the respective voice-time thereof is generated, and the multimedia teaching file is played according to the image-time and voice-time after the image-time of the image-text corresponding to the keyword and the voice-time of the voice-time corresponding to the keyword are read out from the index, and thus the efficacy which a content of multimedia teaching file may be searched and played rapidly.

### BRIEF DESCRIPTION OF THE DRAWINGS

The invention will become more fully understood from the detailed description given herein below illustration only, and thus is not limitative of the present invention, and wherein:

FIG. 1 is a system architecture diagram of a system for browsing a multimedia file according to the present invention;

FIG. 2 is a flowchart of a method for browsing a multimedia file according to the present invention;

FIG. 3A is a schematic diagram of a display range according to an embodiment according to the present invention; and

FIG. 3B is a schematic diagram of a highlighted text recognition area according to an embodiment according to the present invention.

### DETAILED DESCRIPTION

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

The present invention may recognize at least one image and at least one voice signal of played multimedia teaching file, and saving the recognized image-texts, each image-time of the image-texts, the recognized voice-texts and each voice-time of the voice-texts. Then, an index comprising the image-texts, the respective image-time thereof, and the voice-texts and the respective voice-time thereof is generated. Thereafter, when the image-text and the voice-text saved in the index correspond to an inputted keyword, the multimedia teaching file is played according to the image-time corresponding to the keyword or voice-time corresponding to the keyword.

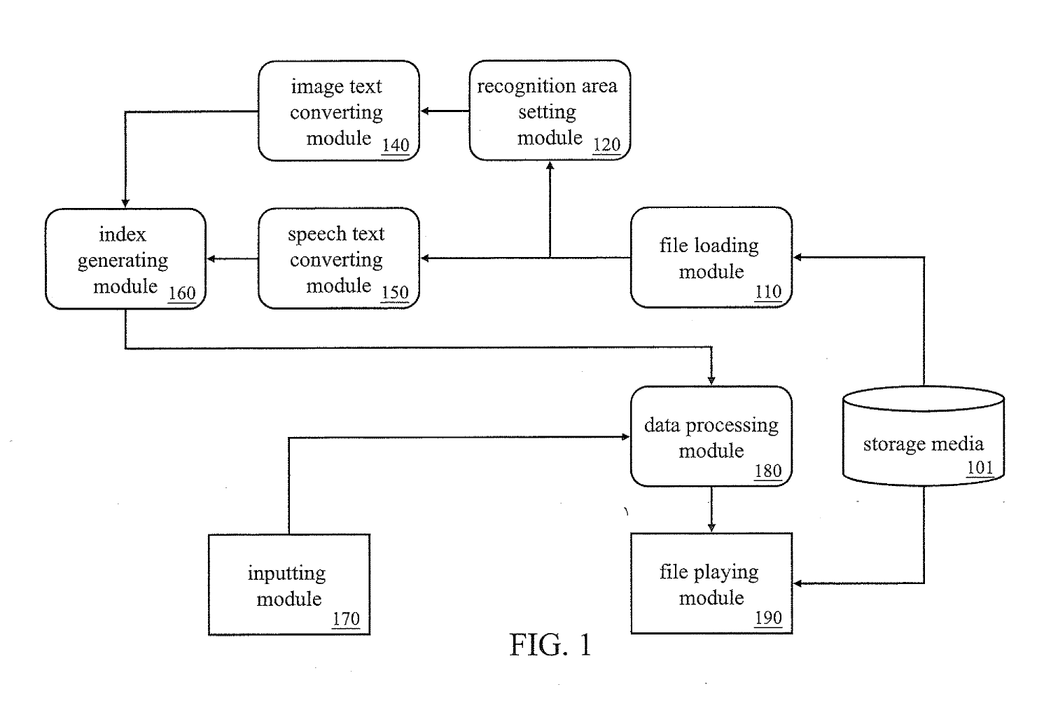

Referring to FIG. 1, in which a system architecture diagram of a system for browsing a multimedia file according to the present invention is schematically shown. The system of the present invention comprises a file loading module 110, a recognition area setting module 120, an image text converting module 130, an image text converting module 140, a speech text converting module 150, an index generating module 160, an inputting module 170, a data processing module 180, and a file playing module 190.

The file loading module 110 loads in an as-prepared multimedia teaching file.

The file loading module 110 reads the multimedia teaching file from a storage media 101 of the present invention, and may download the multimedia teaching file from a storage media (not shown) external to the present invention. However, the file loading module 110 loads in the multimedia teaching file is not limited as that described above.

The recognition setting module 120 is used to set an area of the image in the multimedia teaching file. The area of the image will display a text when the multimedia teaching file is played. For example, the recognition setting module 120 sets a position of blackboard/whiteboard or captions in a frame of the multimedia teaching file when the multimedia teaching file is played. Herein, the area set by the recognition area setting module 120 is termed as “text recognition area”.

The recognition area setting module 120 may provide a function for customizing the text recognition area in the playing area of the image displaying the multimedia teaching file. For example, the recognition area setting module 120 may provide a drag function in the image of the multimedia teaching file, so as to set a highlighted area in the displaying area as the text recognition area. The recognition area setting module 120 may also analyze a frame included in the multimedia teaching file to determine the area of blackboard/whiteboard or captions in the multimedia teaching file and set the determined area as the text recognition area. The recognition area setting module 120 may also compare a plurality of frames of the multimedia teaching file, and set different areas of the compared frames as the text recognition area.

The image text converting module 140 is used to convert the image of the text recognition area into the text in the played multimedia teaching file so as to acquire one or more data after the conversion. In present invention, the data acquired by the image-to-text converting module 140 is termed as “image-text”.

Generally, the image text converting module 140 may use a character recognition technology to recognize an image-text in the frame presented by the multimedia teaching file loaded in by the file loading module 110. That is, the image-text converted by the image text converting module 140 is a message composed by texts or symbols, but which is only an example, not to limit the manners the image text converting module 140 may convert the image-text.

The image text converting module 140 also determines at least one image-time of each image-text converted from the multimedia teaching file loaded in by the file loading module 110, and saves each image-text and each image-time of the image-text. Each image-text acquired by the image text converting module 140 has at least an image-time.

The image-time may include a time of playing the frame corresponding to the image-text converted from the multimedia teaching file. This time is termed as “starting time” herein. The image-time may also include a time of the frame corresponded by the image-text converted and this time presents a length of time for playing the multimedia teaching file, and this time is termed as “lasting time” herein. In fact, the image-time may also both include the starting time and the lasting time, and any presentation of them may be used, without any limitation to the present invention.

The speech text converting module 150 is used to convert the voice signal of the multimedia teaching file loaded in by the file loading module 110 into one or more voice-texts. Then the speech text converting module 150 obtains one or more pieces of data after the converting. In present invention, the data obtained by the speech text converting module 150 is termed as “voice-text”.

Generally, the speech text converting module 150 may use the speech recognition technology, e.g. “speech-to-text” (STT), to recognize the voice-text from the multimedia teaching file loaded in by the file loading module 110. That is, the voice-text recognized by the speech text converting module 150 is a message composed of texts and symbols, and any presentation of them may be used, without any limitation to the present invention.

The speech text converting module 150 also determines each converted voice-text matching the corresponding the voice time of the multimedia teaching file, and saves each voice-text and each voice-time of the voice-text. Similar to the image-text, each voice-text acquired by the speech text converting module 140 has at least a voice-time.

The voice-time may include a time which indicates the corresponding voice-text is played in the multimedia teaching file. This time is termed as “starting time”. The voice-time may also include a length time for playing the voice of multimedia file, and this length time is also termed as “lasting time”. In fact, the voice-time may also both include the starting time and the lasting time, and any presentation of them may be used, without any limitation to the present invention.

The index generating module 160 is used to generate an index, which may be only texts or data in a database, without any limitation to the present invention. Any file having the data format capable of being used to search for the content of the file may be taken as the index of the present invention.

The index generated by the index generating module 160 comprises all of the played-text and all of the starting time of the played-text. The played-text is the image-text generated from the image text converting module 140 and the voice-text generated from the speech text converting module 140. The starting time is composed of all the image-time of the image-text generated from the image text converting module 140 and all the voice-time of the voice-text generated from the speech text converting module 150. Generally, the index module 160 writes the played-text and the starting time in a bundle to the index.

The inputting module 170 is provided with input of a keyword.

The data processing module 180 is used to search the keyword inputted from the inputting module 170 in the index generated by the index generating module 160, confirm the image-text and the voice-text which is corresponding to the keyword in the index, read the image-time of the image-text from the index according to the image-text corresponded by the keyword, and read the voice-time of the voice-text from the index according to the voice-text corresponded by the keyword. In the above, the played-text (the image-text and the voice-text) corresponded by the keyword means the played-text comprises the keyword or the played-text is totally identical to the keyword or including some words in the keyword, which are only examples and not to limit the present invention.

In some embodiments, the data processing module 180 may search for the image-texts and the voice-texts which include the keyword in the index (in the present invention, the played-text is image-text and the voice-text). For example, the data processing module 180 compares the keywords with the image-text and the voice-text saved in the index, so as to search the played-text including the keyword or identical to the keyword. The data processing module 180 may also read the image-time and voice-time of the played-text corresponded by the keyword after searched the played-text corresponding to the keyword. It is to be noted that the present invention also uses “played-time” to indicate the image-time and the voice-time.

In some embodiments, the data processing module 180 reads the image-time and the voice-time from the index according to the image-text and the voice-text corresponded by the keyword when the read image-text and the read voice-text both include the keyword.

The file playing module 190 is used to play the multimedia teaching file loaded in by the file loading module 110 according to the played-time read out from the data processing module 180.

In some embodiments, the file playing module 190 may begin to play the multimedia teaching file according to the starting time of the played-time read out from the data processing module 180. For example, the starting time is 2 minutes and 8 seconds, then the file playing module 190 starts to play the multimedia teaching file from the 2 minutes and 8 seconds of the multimedia teaching file. As another choice, the file playing module 190 may also play the multimedia teaching file earlier than the starting time such as 7 seconds, i.e. the file playing module 190 plays the multimedia teaching file from the time point of 2 minutes and 1 second of the multimedia teaching file.

In some embodiments, the file playing module 190 may also play the multimedia teaching file according to the lasting time in the played-time read out from the data processing module 180. For example, in the case that the lasting time is 4 minutes and 13 seconds, the file playing module 190 will stop playing the multimedia teaching file at a time of 6 minutes and 14 seconds of the multimedia teaching file.

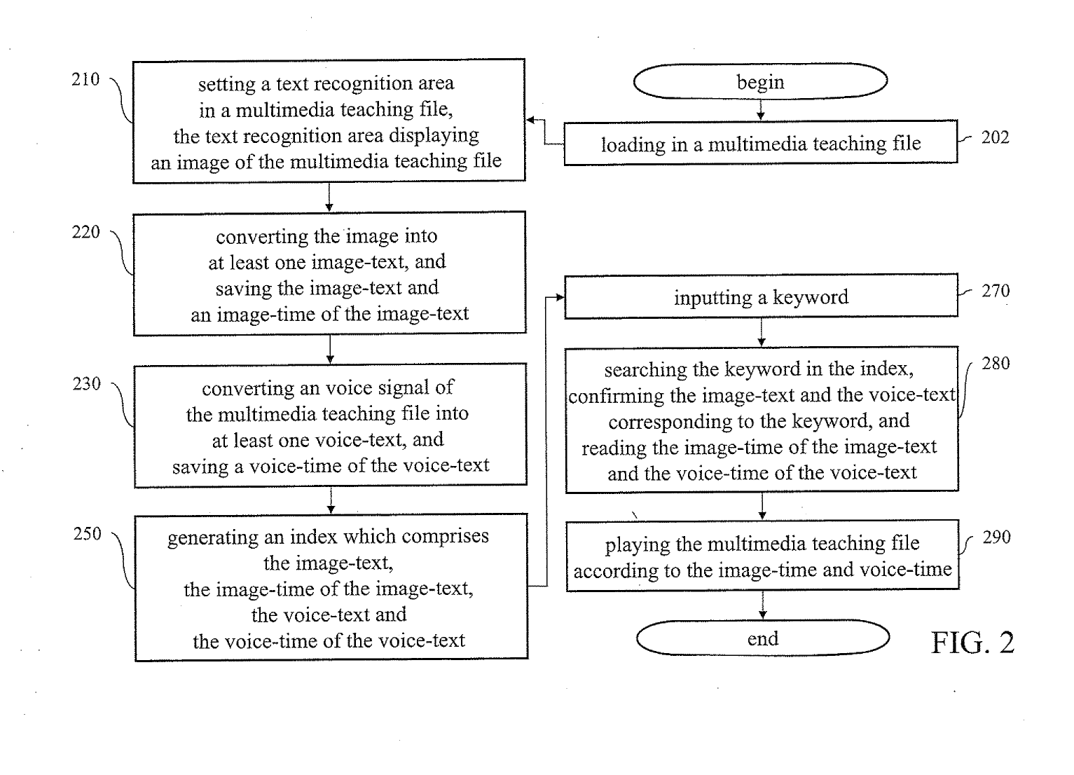

Thereafter, referring to FIG. 2, in which a flowchart of the method for browsing a multimedia file according to the present invention is shown, for description of the present invention in operation and method.

At first, the file loading module 110 may load in a multimedia teaching file (S202). In the present invention, assume the multimedia teaching file is stored in device executing the present invention, and the file loading module 110 may load in the multimedia teaching file from the storage media 101 of the device.

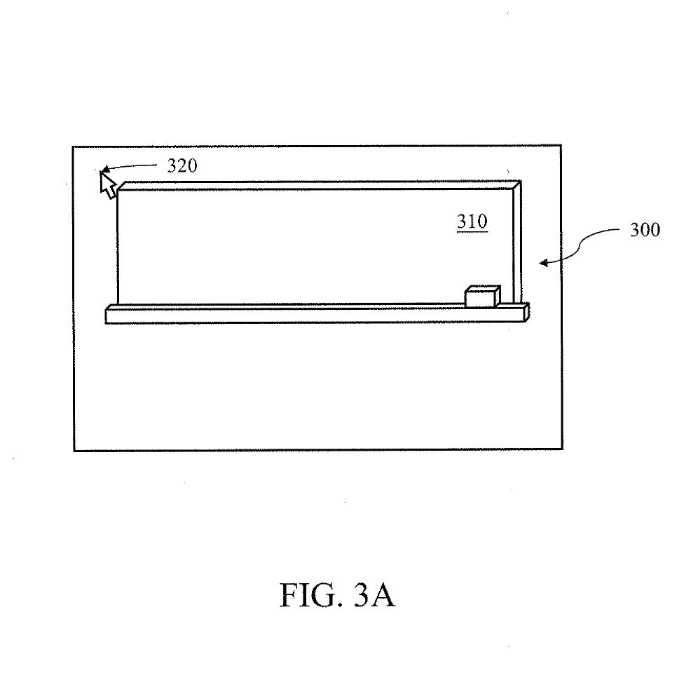

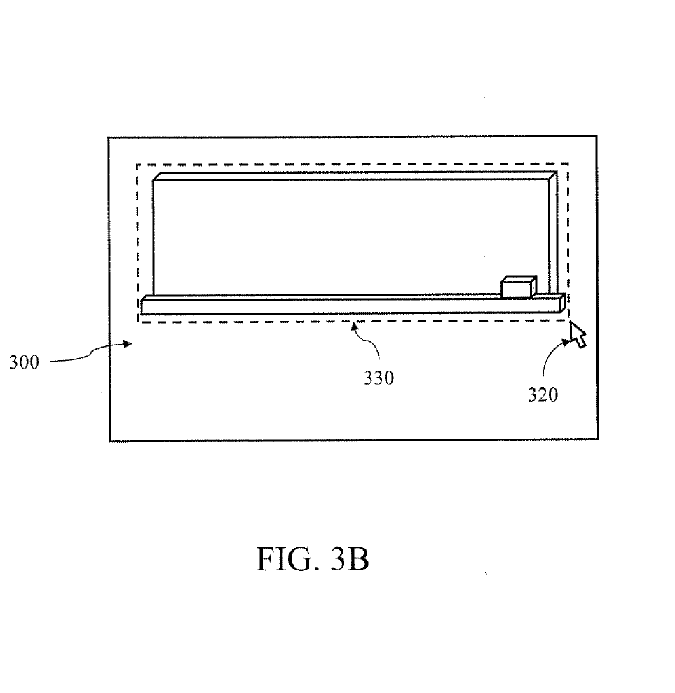

After the file loading module 110 loads in the multimedia teaching file (S202), the recognition area setting module 120 may set a text recognition area (S210). In this embodiment, referring to FIG. 3A and FIG. 3B simultaneously, the recognition area setting module 120 provides a user to set the text recognition area 330 in the display area 300 displaying the multimedia teaching file. The user may use a mouse to control a cursor 320 for selecting an area including a black plate 310 having texts therein from the display area 300 of the played multimedia teaching file. As such, the recognition area setting module 120 may set the area in the display area 300 selected by the user as the text recognition area 330.

After the recognition setting module 120 sets the text recognition area (S210), the image text converting module 140 may convert the image displayed within the text recognition area 330 when the multimedia teaching file is played into one or more image-texts, and save each of the image-texts and each of the image-time of the image-text (S220). In this embodiment, assume the image text converting module 140 recognizes the texts in the image displayed in the text recognition area 330, and saves the time when the text recognition is conducted as the starting time. For example, one of the recognized image-texts is “resistance”, and starting time of the image-text “resistance” in the multimedia teaching file is 13 minutes and 4 seconds. Then, the image text converting module 140 may also determine whether the image-text “resistance” is displayed in the text recognition area 330 continuously, and save the time when the image-text “resistance” is not displayed in the text recognition area 330 as the lasting time, such as 14 minutes and 3 seconds.

Similarly, after the file loading module 110 loads in the multimedia teaching file (S220), the speech text converting module 150 may convert a voice signal into one or more voice-texts in the multimedia teaching file, and save each of the voice-texts and each of the voice-time of the voice-text (S230). In this embodiment, the speech text converting module 150 recognizes the voice in the multimedia teaching file, and saves the time when the voice-text is recognized as the starting time. For example, one of the recognized voice-text as “circuit”, and the voice-text “circuit” has its starting time in the multimedia teaching file as 8 minutes and 2 seconds.

After the image text converting module 140 generates an image-text and saves the image-text and the image-time of the image-text (S220). And after the speech text converting module 150 generates a voice-text and saves the voice-text and the voice-time of the voice-text (S230), the index generating module 160 may generate an index (S250). In this embodiment, the index generated by index generating module 160 includes the image-text “resistance” and the image-time of the image-text “resistance”, i.e. the starting time of 13 minutes and 4 seconds and the lasting time of 14 minutes and 3 seconds, and also includes the voice-text “circuit” and the voice-time of the voice-text “circuit”, i.e. the starting time of 8 minutes and 2 seconds.

After the index generating module 160 generates the index (S250), the inputting module 170 may provide a user interface to the user, and by which a keyword may be inputted (S270). Subsequently, the data processing module 180 may search the keyword inputted from the inputting module 170 from the played-text (the image-text and the voice-text) included in the index generated from the index generating module 160, confirm the played-text which is corresponding to the keyword in the index, and read the played-time (the image-time and the voice-time) corresponded to the played-text from the index according to the played-text corresponded by the keyword (S280). Thereafter, the file playing module 190 may read out the multimedia teaching file from the storage media 101 according to the read played-time from the data processing module 180, and play the read multimedia teaching file (S290).

In this embodiment, if the user inputs “resistance” through the inputting module 170 as the keyword, the data processing module 180 may find a played-text including the keyword or identical to the keyword, and read out a played-time corresponded by the found played-text, i.e. the starting time of 13 minutes and 4 seconds and the lasting time of 14 minutes and 3 seconds. Thereafter, the file playing module 190 begins to play the multimedia teaching file at the time of 13 minutes and 4 seconds, and stops when the play time of the multimedia teaching file reaches 14 minutes and 3 seconds. And if the inputting module 170 is inputted with “circuit” as the keyword, the data processing module 180 may also find the played-text including the keyword or identical to the keyword in the index, and read the corresponding played-time, i.e. the starting time “8 minutes and 2 seconds”. Thereafter, the file playing module 190 may begin to play the multimedia teaching file at the time of 8 minutes and 2 seconds until the multimedia teaching file is totally played.

As such, a user may directly use a keyword to search the multimedia teaching file and browse the content associated with the keyword in the multimedia teaching file.

In view of the above, it may be known that the system and method of the present invention have the main differences as compared to the prior art that a displayed content located within a text recognition area, in playing a multimedia teaching file, is converted into at least one image-text and a voice signal of the multimedia teaching file is converted into at least one voice-text, an index comprising all the image-texts and the respective image-time thereof and all the voice-texts and the respective voice-time thereof is generated, and after the image-time of the image-text corresponding to the keyword and the voice-time of the voice-text corresponding to the keyword are read out from the index, the multimedia teaching file is played according to the read image-time and the read voice-time. Thus the efficacy which a content of multimedia teaching file may be searched and played rapidly.

Furthermore, the method for browsing a multimedia file based on an index establishing according to the present invention may be implemented in hardware, software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for browsing a multimedia file, comprising steps of:
setting a text recognition area in a multimedia teaching file, the text recognition area displaying at least one image of the multimedia teaching file, each of the images correspond to a image-time;
converting the image into at least one image-text, and saving each of the image-texts and each of the image-time of the image;
converting a voice signal of the multimedia teaching file into at least one voice-text, and saving each of the voice-texts and each voice-time of the voice-text;
generating an index which comprises each of the image-texts, the image-time of each image-text, each of the voice-texts, and the voice-time of each voice-text;
inputting a keyword;
searching the keyword in the index, confirming the image-text and the voice-text which are corresponding to the keyword in the index, and reading the image-time of the confirmed image-text and the voice-time of the confirmed voice-text; and
playing the multimedia teaching file according to the read image-time and the read voice-time.

2. The method as claimed in claim 1, wherein the step of setting a text recognition area in a multimedia teaching file further comprises customizing the text recognition area in a playing area.

3. The method as claimed in claim 1, wherein the step of setting a text recognition area in a multimedia teaching file further comprises determining the text recognition area in the multimedia teaching file.

4. The method as claimed in claim 1, wherein the step of playing the multimedia teaching file according to the read image-time and the read voice-time further comprises a step of playing the multimedia teaching file at a starting time of the image-time or the voice-time.

5. The method as claimed in claim 1, wherein the image-time and the voice-time further include a lasting time for playing the multimedia teaching file.

6. The method as claimed in claim 1, wherein the step of reading the image-time of the confirmed image-text and the voice-time of the confirmed voice-text further comprises a step of reading the image-time of the confirmed image-text and the voice-time of the confirmed voice-text which include the keyword.

7. A system for browsing a multimedia file, comprising:
a recognition area setting module, setting a text recognition area in a multimedia teaching file, the text recognition area displaying an image of the multimedia teaching file;
an image text converting module for converting the image into at least one image-text, and saving each of the image-texts and each image-time of the image;
a speech text converting module for converting a voice signal of the multimedia teaching file into at least one voice-text, and saving each of the voice-texts and each voice-time of the voice-text;
an index generating module for generating an index, which comprising each of the image-texts, the image-time of each image-text, each of the voice-texts and the voice-time of each voice-text;
an inputting module for inputting a keyword;
a data processing module for searching the keyword in the index, confirming the image-text and the voice-text which are corresponding to the keyword in the index, and reading the image-time of the confirmed image-text and the voice-time of the confirmed voice-text; and
a file playing module for playing the multimedia teaching file according to the read image-time and the read voice-time.

8. The system as claimed in claim 7, wherein the recognition area setting module customizes the text recognition area in the multimedia teaching file.

9. The system as claimed in claim 7, wherein the recognition area setting module determines the text recognition area in the multimedia teaching file.

10. The system as claimed in claim 7, wherein the data processing module further for reading the image-time of the read image-text and the voice-time of the read voice-text which include the keyword.

11. The system as claimed in claim 7, wherein the file playing module plays the multimedia teaching file at a starting time of the image-time or the voice-time.

12. The system as claimed in claim 7, wherein the image-time and the voice-time include a lasting time of the multimedia teaching file, the file playing module plays the multimedia teaching file according to the lasting time.
